(19) United States
(12) Patent Application Publication
(10) Pub. No.: US 2017/0209986 A1
(43) Pub. Date: Jul. 27, 2017

(54) Ratcheting Spreader System

(71) Applicant: David Sharp, Bethlehem, PA (US)

(72) Inventor: David Sharp, Bethlehem, PA (US)

(21) Appl. No.: 15/007,507

(22) Filed: Jan. 27, 2016

(51) Int. Cl. B25B 5/06; B25B 27/14

(52) U.S. Cl. CPC B25B 5/068; B25B 27/14

(57) ABSTRACT

A ratcheting spreader system includes a construction frame that has a pair of lateral arms. A spreader has a first half is slidably coupled to a second half. The spreader includes an urging unit extending between the first half and the second half. The urging unit may be manipulated thereby spacing the first half a selected distance from the second half. The spreader is selectively positioned between the lateral arms such each of the first half and the second half engages an associated one of the lateral arms. The urging unit urges each of the lateral arms a precise distance apart from each other. Thus, the lateral arms may be secured during construction.

### BACKGROUND OF THE DISCLOSURE

### Field of the Disclosure

The disclosure relates to spreader devices and more particularly pertains to a new spreader device for precisely positioning members during construction

### SUMMARY OF THE DISCLOSURE

An embodiment of the disclosure meets the needs presented above by generally comprising a construction frame that has a pair of lateral arms. A spreader has a first half is slidably coupled to a second half. The spreader includes an urging unit extending between the first half and the second half. The urging unit may be manipulated thereby spacing the first half a selected distance from the second half. The spreader is selectively positioned between the lateral arms such each of the first half and the second half engages an associated one of the lateral arms. The urging unit urges each of the lateral arms a precise distance apart from each other. Thus, the lateral arms may be assembled during construction.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a ratcheting spreader system according to an embodiment of the disclosure.

FIG. 2 is a top phantom view of an embodiment of the disclosure.

FIG. 3 is a cross sectional view taken along line 3-3 of FIG. 2 of an embodiment of the disclosure.

FIG. 4 is a cross sectional view taken along line 4-4 of FIG. 2 of an embodiment of the disclosure.

FIG. 5 is a perspective in-use view of an embodiment of the disclosure.

### DESCRIPTION OF THE PREFERRED EMBODIMENT

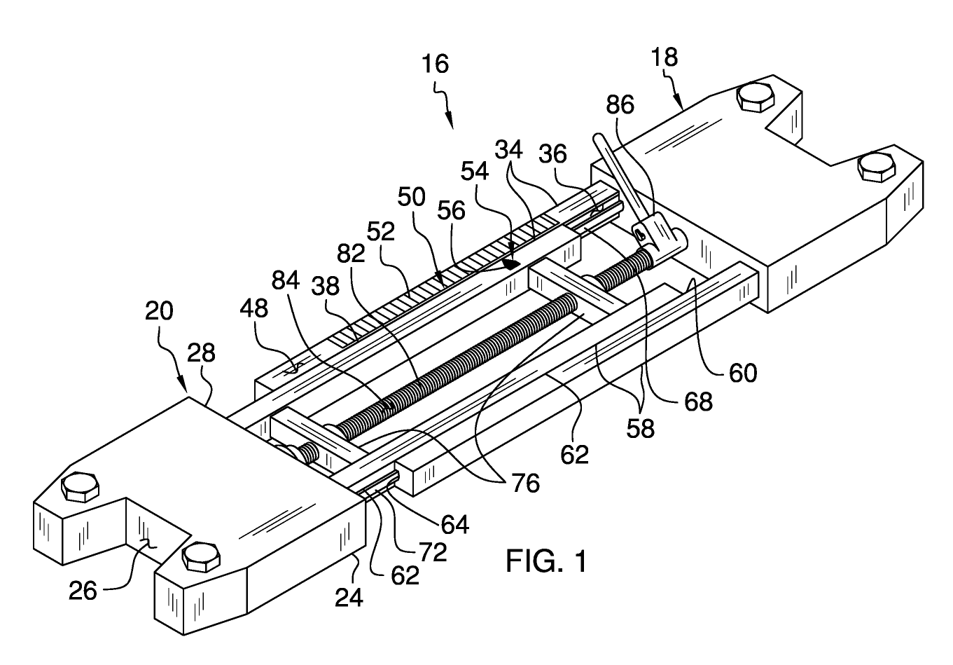

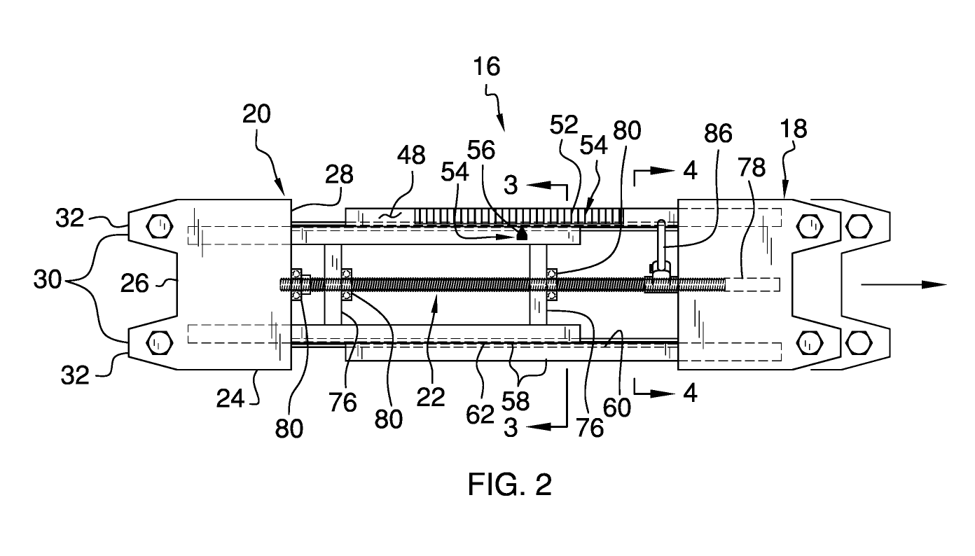

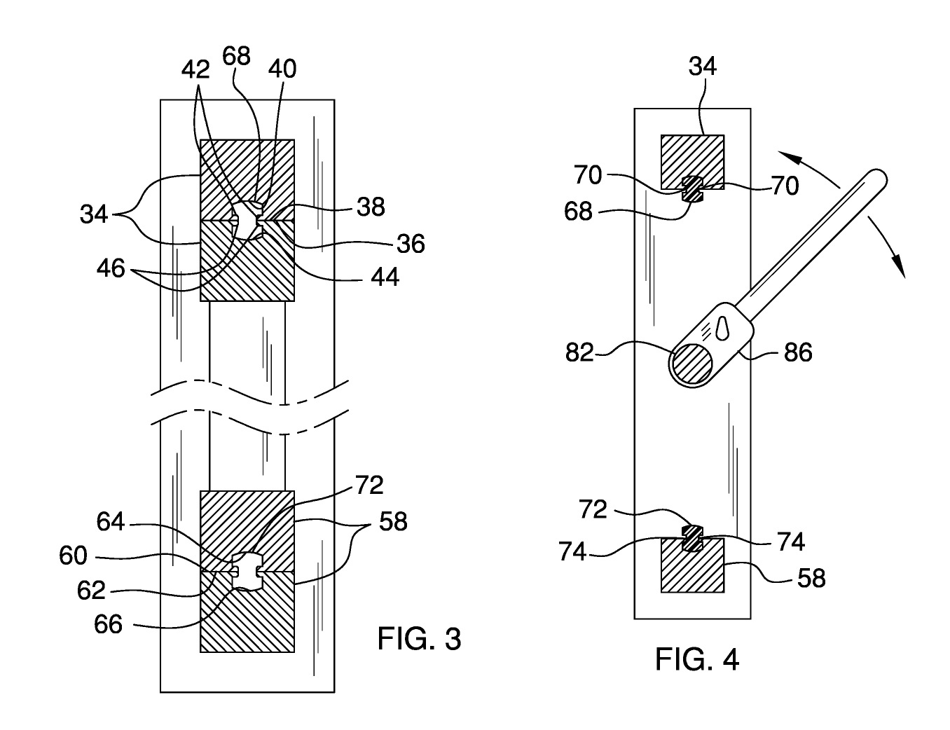

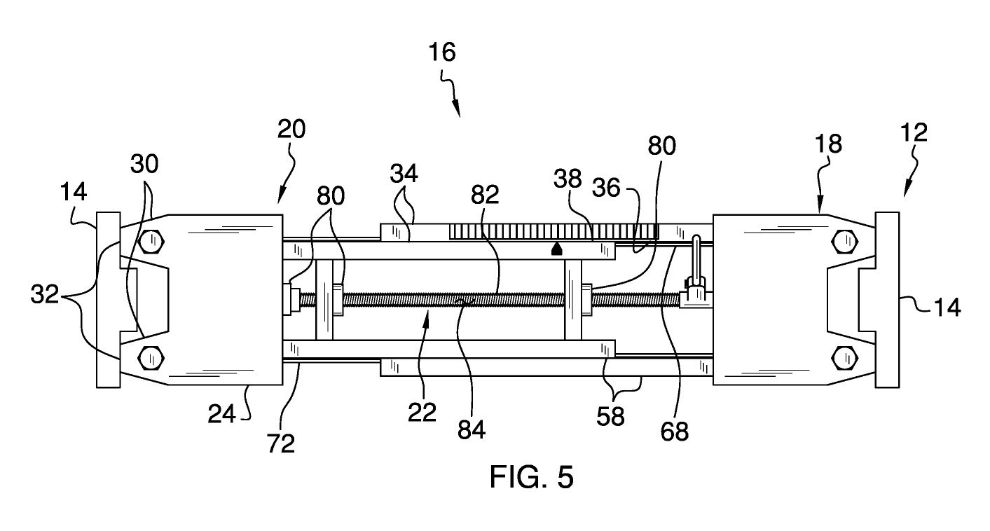

With reference now to the drawings, and in particular to FIGS. 1 through 5 thereof, a new spreader device embodying the principles and concepts of an embodiment of the disclosure and generally designated by the reference numeral 10 will be described.

As best illustrated in FIGS. 1 through 5, the ratcheting spreader system 10 generally comprises a construction frame 12 that has a pair of lateral arms 14. The construction frame 12 may be an opening framed into a wall or the like. The opening may be a doorway or a window. Additionally, each of the lateral arms 14 may be vertically oriented.

A spreader 16 is provided. The spreader 16 has a first half 18 that is slidably coupled to a second half 20. The spreader 16 has an urging unit 22 extending between the first half 18 and the second half 20. The urging unit 22 may be manipulated thereby spacing the first half 18 a selected distance from the second half 20. The spreader 16 is selectively positioned between the lateral arms 14. Thus, each of the first half 18 and the second half 20 engages an associated one of the lateral arms 14.

The urging unit 22 urges each of the lateral arms 14 a precise distance apart from each other. Thus, the lateral arms 14 may be assembled during construction in a precise location. The spreader 16 enhances uniform positioning of the lateral arms 14 with respect to each other. Thus, the construction frame 12 is assembled in a precise manner.

The spreader 16 may be positioned between an object and a support surface. The spreader 16 may be vertically oriented between the object and the support surface. The object may be an overhead cabinet or the like. The support surface may be a countertop or the like. Thus, the spreader 16 may position the object a precise distance from the support surface.

Each of the first half 18 and the second half 20 comprise a plate 24 that has a first lateral surface 26 and a second lateral surface 28. The plate 24 has a pair of feet 30 each extending away from the first lateral surface 26. The feet 30 are spaced apart from each other and each of the feet 30 has a distal end 32 with respect to the first lateral surface 26. The distal end 32 of each of the feet 30 abuts the associated lateral arm 14 when the spreader 16 is positioned between the lateral arms 14.

Each of the first half 18 and the second half 20 include a first arm 34 that is coupled to and extends away from the second lateral surface 28. The first arm 34 corresponding to the first half 18 has an inwardly facing surface 36. The first arm 34 corresponding to the second half 20 has an outwardly facing surface 38. The inwardly facing surface 36 has a slot 40 extending inwardly therein and the slot 40 is longitudinally coextensive with the corresponding first arm 34. The inwardly facing surface 36 may extend inwardly across the slot 40 to define a pair of tabs 42. The tabs 42 may be directed toward each other and the tabs 42 may be spaced apart from each other.

The outwardly facing surface 38 has a slot 44 extending inwardly therein. The slot 44 corresponding to the outwardly facing surface 38 is longitudinally coextensive with the corresponding first arm 34. The outwardly facing surface 38 may extend inwardly across the slot 44 corresponding to the outwardly facing surface 38. Thus, a pair of lips 46 may be defined. The lips 46 may be directed toward each other and the lips 46 may be spaced apart from each other.

The inwardly facing surface 36 corresponding to the first half 18 coextensively abuts the outwardly facing surface 38 corresponding to the second half 20. Thus, the plate 24 corresponding to the first half 18 is oppositionally positioned with respect to the plate 24 corresponding to the second half 20. The first arm 34 of each of the first half 18 and the second half 20 has a top surface 48 and indicia 50 is printed on the top surface 48 corresponding to the first half 18. The indicia 50 comprise a ruler 52. Indicia 54 are printed on the top surface 48 corresponding to the second half 20 and the indicia 54 corresponding to the second half 20 comprise a pointer 56. The pointer 56 is aligned with a selected point on the ruler 52 when the plate 24 corresponding to the first half 18 is spaced from the plate 24 corresponding to the second half 20.

Each of the first half 18 and the second half 20 include a second arm 58 that is coupled to and extends away from the second lateral surface 28. The second arm 58 is spaced from the first arm 34. The second arm 58 corresponding to the first half 18 has an interior facing surface 60. The second arm 58 corresponding to the second half 20 has an exterior facing surface 62. The interior facing surface 60 has a groove 64 extending inwardly therein and the groove 64 is longitudinally coextensive with the corresponding second arm 58.

The exterior facing surface 62 has a groove 66 extending inwardly therein. The groove 66 corresponding to the exterior facing surface 62 is longitudinally coextensive with the corresponding second arm 58. The interior facing surface 60 corresponding to the first half 18 coextensively abuts the exterior facing surface 62 corresponding to the second half 20. Thus, the plate 24 corresponding to the first half 18 is oppositionally positioned with respect to the plate 24 corresponding to the second half 20.

A first rail 68 is fixedly positioned within the slot 40 of the inwardly facing surface 36. The first rail 68 engages the slot 44 of the outwardly facing surface 38. Thus, the first arm 34 of the first half 18 is slidably coupled to the first arm 34 of the second half 20. The first rail 68 is coextensive with the first arm 34 corresponding to the first half 18.

The first rail 68 may have a pair of channels 70 each extending toward a center of the first rail 68. The channels 70 may be positioned on opposite sides of the first rail 68. The tabs 42 corresponding to each of the first half 18 and the second half 20 may engage an associated one of the channels 70. Thus, the first arm 34 of each of the first half 18 and the second half 20 are slidably coupled together.

A second rail 72 is fixedly positioned within the groove 64 of the interior facing surface 60. The second rail 72 engages the groove 66 of the exterior facing surface 62. Thus, the second arm 58 of the first half 18 is slidably coupled to the second arm 58 of the second half 20. The second rail 72 is coextensive with the second arm 58 of the first half 18.

The second rail 72 may have a pair of channels 74 each extending toward a center of the second rail 72. The channels 74 of the second rail 72 may be positioned on opposite sides of the second rail 72. The lips 46 corresponding to each of the first half 18 and the second half 20 may engage an associated one of the channels 74 in the second rail 72. Thus, the second arm 58 of the first half 18 is slidably coupled to the second arm 58 of the second half 20.

A pair of cross braces 76 is provided. Each of the cross braces 76 extends between the first arm 34 of the second half 20 and the second arm 58 of the second half 20. The cross braces 76 are spaced apart from each other and are distributed along the corresponding first arm 34 and the corresponding second arm 58. The second lateral surface 28 of the plate 24 corresponding to the first half 18 has a well 78 extending inwardly therein. The well 78 is centrally positioned on the first half 18.

The urging unit 22 comprises a plurality of bearings 80. Each of the bearings 80 is coupled to an associated one of the cross braces 76 and the second lateral surface 28 of the plate 24 corresponding to the second half 20. Each of the bearings 80 may comprise a ball bearing or the like. A rod 82 extends between the second lateral surface corresponding 28 to the first half 18 and the second lateral surface 28 corresponding to the second half 20. The rod 82 has an outer surface 84 and the outer surface 84 is threaded. The rod 82 extends through each of the cross braces 76 and each of the bearings 80. The rod 82 threadably engages each of the bearings 80 and the rod 82 extends into the well 78.

A ratchet 86 is rotatably coupled to the second lateral surface 28 corresponding to the first half 18. Thus, the ratchet 86 may be manipulated. The rod 82 extends through the ratchet 86 such that the ratchet 86 threadably engages the rod 82. The ratchet 86 selectively urges the rod 82 to rotate in a first direction. Thus, the plate 24 corresponding to the first half 18 is urged away from the plate 24 corresponding to the second half 20. The lateral arms 14 of the construction frame 12 are urged away from each other when the spreader 16 is positioned between the lateral arms 14.

The ratchet 86 selectively urges the rod 82 to rotate in a second direction. Thus, the plate 24 corresponding to the first half 18 is urged toward the plate 24 corresponding to the second half 20. The rod 82 extends into the well 78 when the rod 82 is urged to rotate in the second direction. The ratchet 86 may be a ratcheting handle of any conventional design.

In use, the spreader 16 is positioned between the lateral arms 14. The spreader 16 is horizontally oriented between the lateral arms 14. The ratchet 86 is manipulated to rotate the rod 82 in the first direction. The feet 30 corresponding to each of the first half 18 and the second half 20 engage an associated one the lateral arms 14. The ratchet 86 is manipulated to rotate the rod 82 in the first direction until the pointer 56 is aligned with a selected point on the ruler 52. Thus, the lateral arms 14 are spaced a selected distance apart from each other. The lateral arms 14 are secured in the convention of construction framing. The ratchet 86 is manipulated to rotate the rod 82 in the second direction and the spreader 16 is removed from between the lateral arms 14.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A ratcheting spreader system comprising:
a construction frame having a pair of lateral arms; and
a spreader having a first half being slidably coupled to a second half, said spreader having an urging unit extending between said first half and said second half, said urging unit being configured to be manipulated thereby spacing said first half a selected distance from said second half, said spreader being selectively positioned between said lateral arms such each of said first half and said second half engages an associated one of said lateral arms, said urging unit urging each of said lateral arms a precise distance apart from each other wherein said lateral arms are configured to be secured during construction.

2. The system according to claim 1, wherein each of said first half and said second half comprises a plate having a first lateral surface and a second lateral surface, said plate having a pair of feet each extending away from said first lateral surface, said feet being spaced apart from each other, each of said feet having a distal end with respect to said first lateral surface, said distal end of each of said feet abutting said associated lateral arm when said spreader is positioned between said lateral arms.

3. The system according to claim 2, further comprising a first arm being coupled to and extending away from said second lateral surface, said first arm corresponding to said first half having an inwardly facing surface, said first arm corresponding to said second half having an outwardly facing surface.

4. The system according to claim 3, wherein said inwardly facing surface has a slot extending inwardly therein, said slot being longitudinally coextensive with said corresponding first arm, said outwardly facing surface having a slot extending inwardly therein, said slot corresponding to said outwardly facing surface being longitudinally coextensive with said corresponding first arm.

5. The system according to claim 3, wherein said inwardly facing surface corresponding to said first half coextensively abuts said outwardly facing surface corresponding to said second half having said plate corresponding to said first half being oppositionally positioned with respect to said plate corresponding to said second half.

6. The system according to claim 3, wherein said first arm of each of said first half and said second half having a top surface, said top surface corresponding to said first half having indicia being printed thereon, said indicia comprising a ruler, said top surface corresponding to said second half having indicia being printed thereon, said indicia corresponding to said second half comprising a pointer, said pointer being aligned with a selected point on said ruler when said first half is spaced from said second half.

7. The system according to claim 2, further comprising a second arm being coupled to and extending away from said second lateral surface, said second arm being spaced from a first arm, said second arm corresponding to said first half having an interior facing surface, said second arm corresponding to said second half having an exterior facing surface.

8. The system according to claim 7, wherein said interior facing surface has a groove extending inwardly therein, said groove being longitudinally coextensive with said corresponding second arm, said exterior facing surface having a groove extending inwardly therein, said groove corresponding to said exterior surface being longitudinally coextensive with said corresponding second arm.

9. The system according to claim 7, wherein said interior facing surface corresponding to said first half coextensively abuts said exterior facing surface corresponding to said second half having said plate corresponding to said first half being oppositionally positioned with respect to said plate corresponding to said second half.

10. The system according to claim 4, further comprising a first rail being fixedly positioned within said slot of said inwardly facing surface, said first rail engaging said slot of said outwardly facing surface such that said first arm of said first half is slidably coupled to said first arm of said second half, said first rail being coextensive with said first arm corresponding to said first half.

11. The system according to claim 8, wherein a second rail being fixedly positioned within said groove of said interior facing surface, said second rail engaging said groove of said exterior facing surface such that said second arm of said first half is slidably coupled to said second arm of said second half, said second rail being coextensive with said second arm of said first half.

12. The system according to claim 1, wherein:
said second half includes a first arm and a second arm; and
said second half has a pair of cross braces each extending between said first arm of said second half and said second arm of said second half, said cross braces being spaced apart from each other and being distributed along said corresponding first arm and said corresponding second arm.

13. The system according to claim 2, wherein said second lateral surface corresponding to said first half has a well extending toward said first lateral surface corresponding to said first half, said well being centrally positioned on said first half.

14. The system according to claim 2, wherein said urging unit comprises a plurality of bearings, each of said bearings being coupled to an associated one of said cross braces and a second lateral surface of said second half.

15. The system according to claim 14, further comprising a rod extending between said second lateral surface corresponding to said first half and said second lateral surface corresponding to said second half, said rod having an outer surface, said outer surface being threaded, said rod extending through each of said cross braces and each of said bearings, said rod threadably engaging each of said bearings, said rod extending into said well.

16. The system according to claim 15, wherein a ratchet being rotatably coupled to said second lateral surface corresponding to said first half wherein said ratchet is configured to be manipulated, said rod extending through said ratchet such that said ratchet threadably engages said rod.

17. The system according to claim 16, wherein:
said ratchet selectively urges said rod to rotate in a first direction such that said plate corresponding to said first half is urged away from said plate corresponding to said second half such that said lateral arms of said construction frame are urged away from each other when said spreader is positioned between said lateral arms; and
said ratchet selectively urging said rod to rotate in a second direction such that said plate corresponding to said first half is urged toward said plate corresponding to said second half, said rod extending into said well when said rod is urged to rotate in said second direction.

18. A ratcheting spreader system comprising:
a construction frame having a pair of lateral arms; and
a spreader having a first half being slidably coupled to a second half, said spreader having an urging unit extending between said first half and said second half, said urging unit being configured to be manipulated thereby spacing said first half a selected distance from said second half, said spreader being selectively positioned between said lateral arms such each of said first half and said second half engages an associated one of said lateral arms, said urging unit urging each of said lateral arms a precise distance apart from each other wherein said lateral arms are configured to be assembled during construction, each of said first half and said second half comprising:
a plate having a first lateral surface and a second lateral surface, said plate having a pair of feet each extending away from said first lateral surface, said feet being spaced apart from each other, each of said feet having a distal end with respect to said first lateral surface, said distal end of each of said feet abutting said associated lateral arm when said spreader is positioned between said lateral arms,
a first arm being coupled to and extending away from said second lateral surface, said first arm corresponding to said first half having an inwardly facing surface, said first arm corresponding to said second half having an outwardly facing surface, said inwardly facing surface having a slot extending inwardly therein, said slot being longitudinally coextensive with said corresponding first arm, said outwardly facing surface having a slot extending inwardly therein, said slot corresponding to said outwardly facing surface being longitudinally coextensive with said corresponding first arm, said inwardly facing surface corresponding to said first half coextensively abutting said outwardly facing surface corresponding to said second half having said plate corresponding to said first half being oppositionally positioned with respect to said plate corresponding to said second half, said first arm of each of said first half and said second half having a top surface, said top surface corresponding to said first half having indicia being printed thereon, said indicia comprising a ruler, said top surface corresponding to said second half having indicia being printed thereon, said indicia corresponding to said second half comprising a pointer, said pointer being aligned with a selected point on said ruler when said first half is spaced from said second half, and
a second arm being coupled to and extending away from said second lateral surface, said second arm being spaced from said first arm, said second arm corresponding to said first half having an interior facing surface, said second arm corresponding to said second half having an exterior facing surface, said interior facing surface having a groove extending inwardly therein, said groove being longitudinally coextensive with said corresponding second arm, said exterior facing surface having a groove extending inwardly therein, said groove corresponding to said exterior surface being longitudinally coextensive with said corresponding second arm, said interior facing surface corresponding to said first half coextensively abutting said exterior facing surface corresponding to said second half having said plate corresponding to said first half being oppositionally positioned with respect to said plate corresponding to said second half,
a first rail being fixedly positioned within said slot of said inwardly facing surface, said first rail engaging said slot of said outwardly facing surface such that said first arm of said first half is slidably coupled to said first arm of said second half, said first rail being coextensive with said first arm corresponding to said first half, and
a second rail being fixedly positioned within said groove of said interior facing surface, said second rail engaging said groove of said exterior facing surface such that said second arm of said first half is slidably coupled to said second arm of said second half, said second rail being coextensive with said second arm of said first half;
said second half having a pair of cross braces each extending between said first arm of said second half and said second arm of said second half, said cross braces being spaced apart from each other and being distributed along said corresponding first arm and said corresponding second arm;
said second lateral surface corresponding to said first half having a well extending toward said first lateral surface corresponding to said first half, said well being centrally positioned on said first half; and
said urging unit comprising:
a plurality of bearings, each of said bearings being coupled to an associated one of said cross braces and said second lateral surface of said second half,
a rod extending between said second lateral surface corresponding to said first half and said second lateral surface corresponding to said second half, said rod having an outer surface, said outer surface being threaded, said rod extending through each of said cross braces and each of said bearings, said rod threadably engaging each of said bearings, said rod extending into said well, and
a ratchet being rotatably coupled to said second lateral surface corresponding to said first half wherein said ratchet is configured to be manipulated, said rod extending through said ratchet such that said ratchet threadably engages said rod, said ratchet selectively urging said rod to rotate in a first direction such that said plate corresponding to said first half is urged away from said plate corresponding to said second half such that said lateral arms of said construction frame are urged away from each other when said spreader is positioned between said lateral arms, said ratchet selectively urging said rod to rotate in a second direction such that said plate corresponding to said first half is urged toward said plate corresponding to said second half, said rod extending into said well when said rod is urged to rotate in said second direction.
